(19) United States
(12) Patent Application Publication
(10) Pub. No.: US 2025/0213327 A1
(43) Pub. Date: Jul. 3, 2025

(54) MANUFACTURE OF A RETAINER

(71) Applicant: DENTAL MONITORING, PARIS (FR)

(72) Inventors: Thomas PELLISSARD, MAISONS-ALFORT (FR); Guillaume GHYSELINCK, CANTIN (FR)

(21) Appl. No.: 18/850,920

(22) PCT Filed: Mar. 31, 2023
(86) PCT No.: PCT/EP2023/058461

§ 371 Date: Sep. 25, 2024

(30) Foreign Application Priority Data
Mar. 31, 2022 (FR) FR2202939

(51) Int. Cl. A61C 7/00; A61C 7/20; G06Q 10/083

(52) U.S. Cl. CPC A61C 7/002; A61C 7/20; G06Q 10/083

(57) ABSTRACT

A process for manufacturing a retainer, said process comprising the following steps: a) at an update time, after the end of an orthodontic treatment, acquiring at least one two-dimensional image of at least one portion of a dental arch of a user, called the “updated image”, by means of an image-acquiring apparatus; b) generating a digital three-dimensional model representing the dental arch of the user, called the “updated model”, based on the updated image; c) designing, based on the updated model and preferably by computer, a retainer suitable for keeping teeth in their configuration at the update time; d) manufacturing the retainer.

### TECHNICAL FIELD

The present invention concerns processes and devices for the design and manufacture of orthodontic retainers.

### STATE OF THE ART

After orthodontic treatment, the position of the teeth may change. This unfavorable change is generally referred to as a “relapse”. Traditionally, patients visit their orthodontist at regular intervals for check-ups. They can also visit their dentist, who can detect any imperfections in tooth positioning.

However, many patients do not undergo these check-ups, which would enable the detection of possible relapses. The teeth can thus return to a malocclusion position which, to be corrected, requires further orthodontic treatment, which can be as extensive as the initial treatment.

Visits are burdensome for the patient and stressful for the orthodontist. Patent application US 2018/0204332 describes a process for partially solving this problem. However, at the end of orthodontic treatment, it is necessary to acquire at least one digital, three-dimensional reference model of the patient's arches. The patient is therefore obliged to visit the orthodontist.

To prevent unfavorable changes in tooth position, and thus limit the number of appointments, patients may be asked to wear a retainer to keep their teeth in the position obtained at the end of orthodontic treatment.

The retainer is typically an orthodontic retaining tray or archwire, consisting of a wire forming an arch and secured against the teeth, usually bonded against the lingual surfaces from canine to canine. The shape of the orthodontic appliance is usually determined by the orthodontist through the acquisition of a 3D scan of the patient's dental arch after orthodontic treatment has been completed.

Acquiring a 3D scan of the patient's dental arch is time-consuming and requires the patient to travel.

There is a need to make it easier to determine and manufacture orthodontic retainers following orthodontic treatment.

One aim of the present invention is to at least partially meet this need.

### DISCLOSURE OF THE INVENTION

### Summary of the Invention

The invention aims to meet some or all of these needs and, according to one of its aspects, achieves this by means of a process for manufacturing a retainer comprising the following steps:
a) preferably at an update time, at the end or after the end of an orthodontic treatment, acquiring at least one two-dimensional image of at least part of a dental arch of a user, called the “updated image”, by means of an image-acquiring apparatus; preferably several updated images are acquired;
b) generating a digital three-dimensional model representing the user's dental arch, known as the “updated model”, preferably from the updated image;
c) designing a retainer, based on the updated model, the retainer being designed to keep the teeth in their configuration at the update time when positioned on said teeth;
d) manufacturing the retainer.

Preferably, in step b) the updated model is obtained by deforming, based on the updated image, a digital three-dimensional model of the user's dental arch, known as the “reference model”, acquired prior to step a). The reference model is deformed, starting from the updated image, until an updated model is obtained representing the dental arch in a configuration compatible with the configuration of the dental arch as represented on the updated image.

As will be seen in greater detail later in the description, the updated image can be taken outside the orthodontic practice, and the reference model may have been generated before or during orthodontic treatment. In particular, no intraoral scan is required after orthodontic treatment in order to manufacture the retainer. In this way, the retainer can be determined and manufactured without the user needing to visit the dental care professional after orthodontic treatment has been completed, or even to see the dental care professional at all.

A process according to the invention can thus advantageously limit the number of appointments with the dental care professional.

A process according to the invention may comprise one or more of the following optional features:
the retainer is an archwire or an orthodontic retaining tray, preferably an archwire;
multiple updated images are acquired, preferably 3, preferably 4, preferably 5;
multiple updated images are acquired at different acquisition angles, the updated images preferably comprising at least one image on the right with respect to the user, at least one image on the left with respect to the user, at least one image facing the user;
the updated image is acquired by the user or someone close to them;
the acquisition in step a) takes place outside an orthodontic or dental practice, preferably at the user's home;
the image-acquiring apparatus is a cell phone;
a dental retractor and/or an image acquisition kit, for example as described in EP 3 391 810, is used in step a);
the image acquisition kit takes the form of a box to which the image-acquiring apparatus is attached;
the housing is in the form of a tube having a first opening designed to be positioned in the user's mouth and a second opening designed to be attached to the image-acquiring apparatus so that the image-acquiring apparatus acquires at least one image of the user's teeth through said openings;
in step b) the updated model is obtained by deforming, based on the updated image, a digital three-dimensional model of the user's dental arch, known as the “reference model”, acquired prior to step a);
the reference model is produced from a three-dimensional digital model, from preferably from a digital three-dimensional model acquired before the start of orthodontic treatment or during orthodontic treatment, for example by means of a 3D scanner;
the reference model is an updated model, called a “historical updated model”, resulting from the implementation of a process according to the invention, the historical updated model having preferably been stored in a database after step b);
the reference model is a three-dimensional digital model of the user's dental arch generated at the start of orthodontic treatment, in particular to model the dental arch at a stage of orthodontic treatment, or during orthodontic treatment, for example more than 2 weeks or more than a month before step b);
preferably, the reference model represents the user's dental arch in a desired theoretical configuration at an intermediate time of orthodontic treatment or at a final time of orthodontic treatment;
preferably, the reference model represents the dental arch in a final configuration corresponding to the theoretical configuration desired at the end of orthodontic treatment;
the reference model is deformed using a metaheuristic method or a neural network;
in step b), preferably before step b), preferably in step a), more preferably before step a), the reference model is cut into tooth models, the deformation comprising a displacement of the tooth models equal to the difference in tooth positioning between the tooth configuration in the reference model and the tooth configuration in the updated image;
in step b) or preferably before step b), preferably in step a), even more preferably before step a), at least one neural network is trained, from a learning base, to determine an updated model at the output of the neural network, based on a reference model and an updated image submitted at the input of the neural network, the training base being made up of historical images and first historical models, similar respectively to the updated image and to the reference model, and of second historical models, similar to the updated model as expected at the output of the neural network;
in step b), the updated model is obtained without using a reference model, in particular by assembling tooth models selected on the basis of the updated images;
in step c), the design of the orthodontic appliance involves determining the curvature of an archwire;
preferably, the archwire is designed to adapt to the shape of the teeth to which the archwire is to be applied, the archwire typically being designed to be attached to an inner surface of the user's teeth;
steps b) to c) are carried out by computer, preferably automatically, that is, without operator intervention, or under the supervision of an operator, e.g. a technician or dental care professional;
step d) is carried out using a 3D printer;
the process according to the invention comprises, after step d), the following step e):
e) shipping the retainer to the user or dental care professional.

In one embodiment, the updated model is obtained by implementing a dental arch modeling process, preferably by a user's cell phone, said modeling process comprising the following steps:
1) analysis of the updated image to determine at least one tooth zone and at least one tooth attribute value associated with said tooth zone, preferably a type or number of the tooth to which the tooth zone belongs;
2) for each tooth zone determined in step 1), searching, in a historical library comprising more than 1000 tooth models associated with said tooth attribute value, called “historical tooth models”, to find a historical tooth model having maximum proximity to the tooth zone, called the “optimal tooth model”;
3) arranging the set of optimal tooth models to create a model that maximally matches the updated image, that is, the updated model.

The modeling process preferably comprises one or more of the following features:
steps 1) and 2) of the modeling process are carried out for multiple updated images, and preferably, in steps 2) and 3), it is sought to obtain optimal tooth models and a model assembled in such a way as to maximally match the set of updated images;
the attribute of a tooth is selected from tooth type, tooth number, tooth thickness, tooth crown height, mesio-palatal width of the tooth, deflection index mesial and distal to the incisal edge of the tooth, tooth color, tooth shape, tooth contour, clinical state of the tooth, e.g. “decayed tooth”, “broken tooth”, a relative position of the tooth to another tooth, or to a fixed reference frame relative to the arch, and combinations of these attributes;
multiple attributes are associated with the tooth zone and historical tooth models;
in step 2), the proximity is a shape proximity evaluated by the difference between the shape of the tooth represented on the tooth zone and the shape of the historical tooth model, preferably by the shape difference between the tooth zone and a view of the historical tooth model which has the shape closest to that of the tooth zone;
the view of the historical tooth model with the shape closest to that of the tooth zone is sought using a metaheuristic process, preferably evolutionary, preferably simulated annealing, or a neural network.

In one embodiment, the reference model that is deformed to obtain the updated model is a model generated by the user, preferably with his cell phone.

In particular, at an moment prior to the update time, for example at an orthodontic treatment stage, the user can use the modeling process described above to define an “earlier” updated model from “earlier” updated images and use this earlier updated model as a reference model.

To produce the updated model, or a so-called reference model, the user can also scan said dental arch using a portable scanner, for example of the LIDAR type, preferably a cell phone LIDAR, or by analyzing a series of images representing a luminous mark. In particular, he can implement, preferably with his cell phone, a process for generating a digital three-dimensional model of a dental arch comprising the following steps:
I) projecting at least one light beam onto the user's dental arch, so as to place at least one light mark on the arch;
II) simultaneously with step I), moving the dental arch through the beam and acquiring, during said movement, a series of “marked” images of said arch, each showing a representation of the projected mark, or “projection”;
III) identifying said projection on each marked image, then producing a digital three-dimensional model that maximally matches the set of projections.

In one embodiment, the generating process is implemented before the update time to generate a reference model, and the updated images are used to update the reference model.

In one embodiment, the generating process is implemented at the update time to generate a reference model, and the updated images are used to correct any mistakes in the reference model.

Preferably, steps b) to e) are carried out by computer, preferably automatically, that is, without operator intervention, or under the supervision of an operator, e.g. a technician or dental care professional.

Preferably, when the retainer is an archwire, the retainer is sent to the dental care professional.

When the retainer is an archwire, the process preferably comprises,
in design step c), designing, based on the updated model, an orthodontic transfer tray for containing the retainer and an adhesive substance so that when the orthodontic transfer tray is positioned on the user's teeth, the retainer is positioned and secured on the user's teeth in a position to keep the user's teeth in their configuration at the update time; and
in step d) of manufacturing the archwire, manufacturing the orthodontic transfer tray.

The adhesive can be made of a composite material. Preferably, the adhesive comprises a combination of silane-coated inorganic particles and dimethacrylic resin, for example of the “ENAMEL plus HRI Flow HF” type. The adhesive may comprise composites containing “Bis GMA” and/or “Bis EMA”, for example “Braceplaste”.

In step e), the archwire can be sent inside the orthodontic transfer tray, preferably to the dental care professional or to the user, preferably to the dental professional.

The invention further relates to a computer program product comprising instructions which, when the program is executed by a computer, cause the computer to carry out the following steps:
a′) receiving at least one two-dimensional image, representing a user's dental arch after completion of orthodontic treatment, referred to as an “updated image”;
b) generating a digital three-dimensional model representing the user's dental arch, known as the “updated model”, from the updated image, preferably the generating of the updated model is carried out by deforming, from the updated image, a digital three-dimensional model of the user's dental arch, acquired before step a′), known as the “reference model”;
c) designing a retainer based on the updated model;
the updated image received in step a′) being acquired by the image-acquiring apparatus.

Preferably, the computer program product comprises, after step c), a step d) comprising the sending of manufacturing instructions, preferably via digital communications, to an orthodontic appliance manufacturer or directly to a manufacturing device, e.g. a 3D printer.

The invention further relates to:
a computer program product according to the invention,
a data medium on which such a product is recorded, for example a memory or a CD-ROM, and
a computer wherein such a product is loaded.

The medium can be a computer memory, a hard drive or a CD ROM.

The invention further relates to a design kit for a retainer comprising:
an image-acquiring apparatus, preferably a cell phone,
a computer program product according to the invention, preferably recorded on a medium and loaded into a computer, optionally comprising a code for the step of sending manufacturing instructions;
   the image-acquiring apparatus being in communication with the computer so as to transmit to it the updated image it has acquired.

The computer program product can be a specialized application installed on the image-acquiring apparatus, the image-acquiring apparatus preferably being a cell phone.

The kit may further comprise a device for manufacturing an orthodontic appliance, such as a 3D printer, configured to receive retainer manufacturing instructions from the computer running the computer program product.

The kit may further comprise a transport vehicle, designed to carry the retainer from a manufacturing site of said retainer to a delivery site of said retainer, the delivery site preferably being the user's home and/or the office of the user's dental care professional.

### Definitions

The term “user” means any person for whom a process according to the invention is implemented, whether that person is ill or not.

The term “dental care professional” refers to any person qualified to provide dental care, including in particular orthodontists and dentists.

An “orthodontic treatment” is all or part of a treatment intended to modify a patient's dental configuration. Treatment intended to maintain tooth configuration (retention treatment) is not considered orthodontic treatment.

A 3D scanner, or “scanner”, is a device that produces a 3D model of a dental arch.

An “update time” is a moment during which one or more updated images are acquired. The duration of this moment is short enough that the tooth configuration does not change significantly during this time.

The term “model” means a three-dimensional digital model. A model is made up of a set of voxels. An “arch model” is a model representing at least part of a dental arch, preferably at least 2, preferably at least 3, most preferably at least 4 teeth. FIG. 3 is an example of an arch model.

A “tooth model” is a three-dimensional digital model of a tooth in a user's arch. An arch model can be cut to define tooth models for at least some, preferably all, of the teeth represented in the arch model. Tooth models are therefore models within the arch model. FIG. 4 shows an example of an arch model divided into tooth models.

A “scenario” is a sequence of arch models representing successive arch configurations. In particular, a “treatment scenario”, or “treatment plan”, comprises models that represent configurations of an arch at different moments in its treatment. These moments are typically the initial moment, before the start of treatment, intermediate moments during treatment, and the final moment, at the end of treatment. Each scenario model representing the arch in its expected configuration at an intermediate moment is called an “intermediate model”. FIG. 2 shows an example of a treatment scenario.

A measurement of the difference between two objects is called a “match” or “fit”. A “best fit” is the result of optimization to minimize said difference.

In particular, an updated image maximally matches a model of when a view of this model provides an image that maximally matches the updated image.

A “tooth zone” is an area of an image representing, at least partially, a tooth.

The term “historical tooth model” refers to a tooth model enriched with its description.

“Proximity” is a measure of one or more differences between the historical tooth model and the tooth zone. These differences may comprise a difference in shape, but also other differences such as translucency or color. Maximum proximity can be sought by successively minimizing several differences, or by minimizing a combination of these differences, e.g. a weighted sum of these differences.

“Proximity” is therefore a broader notion than “match”, since a match only measures proximity in terms of shape.

The arch configurations at intermediate and final moments are theoretical, as they result from a simulation for a future moment. They are therefore anticipated, or “predicted”, and may therefore differ from reality at the intermediate or final moment. Viewing the models in a scenario chronologically simulates the effect of the arch treatment.

An arch configuration is said to be “real” when it is that of the user's arch in reality. An arch configuration is said to be “theoretical” when it is that of the user's arch as “simulated”, “predicted” or “desired” for a future moment.

An example of software for manipulating tooth models and creating a treatment scenario is the program Treat, described at https://en.wikipedia.org/wiki/Clear_aligners#cite_note-invisalignsystem-10. U.S. Pat. No. 5,975,893A also describes the creation of a treatment scenario.

An “image” refers to a two-dimensional image, such as a photograph or a video frame. An image is made up of pixels.

The “acquisition conditions” specify the position in space, the orientation in space and the calibration, for example the values for aperture and/or exposure time and/or focal length and/or sensitivity,
of a real image-acquiring apparatus, relative to a user's dental arch (real acquisition conditions) or
of a virtual image-acquiring apparatus, relative to a user's dental arch (virtual acquisition conditions).

The “calibration” of an acquiring apparatus is made up of all the calibration parameter values. A calibration parameter is a parameter intrinsic to the acquiring apparatus (unlike its position and orientation) whose value influences the acquired image. For example, the aperture value is a calibration parameter that modifies the depth of field. Exposure time is a calibration parameter that modifies the brightness (or “exposure”) of the image. Focal length is a calibration parameter that modifies the angle of view, that is, the degree of “zoom”. “Sensitivity” is a calibration parameter that modifies the reaction of a digital acquiring apparatus's sensor to incident light.

Preferably, calibration parameters are chosen from the group formed by aperture, exposure time, focal length and sensitivity.

An observation of a model, under specified virtual acquisition conditions, in particular with calibration of a virtual acquiring apparatus, at a specified angle and distance, is called a “view”.

The terms “image of an arch”, “view of an arch”, “representation of an arch”, “scan of an arch”, or “model of an arch” mean an image, view, representation, scan or model of all or part of said dental arch.

A model of a user's dental arch is “compatible” with an image when there is a view of that model that corresponds to said image, that is, such that the representations of the teeth in the view are positioned, relative to each other, like the representations of the teeth on the image. The contours of the tooth models represented on the view are therefore substantially superimposable in alignment with the contours of the representations of said teeth on the image.

This view of the model can also be described as “compatible”, or “superimposable in alignment”, with said image.

The term “light mark” refers to the interaction between a beam of light and a dental arch. A light mark can be a dot, a line, a stripe or a set of dots and/or lines and/or stripes. A line can therefore be continuous or locally interrupted and made up of pieces of line. It can be of constant or variable width. The representation of a light mark, particularly in an updated image, varies depending on the direction in which the mark is viewed.

The term “light” includes all electromagnetic waves from infrared to ultraviolet.

“Metaheuristic” methods are well-known optimization methods. They are preferably selected from the group formed by
evolutionary algorithms, preferably chosen from:
evolution strategies, genetic algorithms, differential evolution algorithms, estimation of distribution algorithms, artificial immune systems, Shuffled Complex Evolution path relinking, simulated annealing, ant colony algorithms, particle swarm optimization algorithms, Tabu search, and the GRASP method;
the kangaroo algorithm, the Fletcher-Powell method, the noise method, stochastic tunneling, random-restart hill climbing, the cross-entropy method, and
hybrid methods between the above-mentioned metaheuristic methods.

Deep learning algorithms are well known to the person skilled in the art. They comprise “neural networks” or “artificial neural networks”.

The person skilled in the art knows how to choose a neural network, depending on the task in hand. In particular, a neural network can be selected from:
networks specialized in image classification, called “CNN” (“Convolutional neural network”), e.g. AlexNet (2012), ZF Net (2013), VGG Net (2014), GoogleNet (2015), Microsoft ResNet (2015), Caffe: BAIR Reference Caff eNet,

BAIR AlexNet, Torch VGG CNN S, VGG CNN M, VGG_CNN_M_2048, VGG_CNN_M_1024, VGG CNN M 128, VGG CNN F, VGG ILSVRC-2014 16-layer, VGG ILSVRC-2014 19-layer, Network-in-Network (Imagenet & CIFAR-10), Google: Inception (V3, V4);
networks specializing in locating and detecting objects in an image, Object Detection Networks, e.g. R-CNN (2013), SSD (Single Shot MultiBox Detector: Object Detection network), Faster R-CNN (Faster Region-based Convolutional Network method: Object Detection network), Faster R-CNN (2015), SSD (2015), RCF (Richer Convolutional Features for Edge Detection) (2017), SPP-Net, 2014, OverFeat (Sermanet et al.), 2013, GoogleNet (Szegedy et al.), 2015, VGGNet (Simonyan and Zisserman), 2014, R-CNN (Girshick et al.), 2014, Fast R-CNN (Girshick et al.), 2015, ResNet (He et al.), 2016, Faster R-CNN (Ren et al.), 2016, FPN (Lin et al.), 2016, YOLO (Redmon et al.), 2016, SSD (Liu et al.), 2016, ResNet v2 (He et al.), 2016, R-FCN (Dai et al.), 2016, ResNext (Lin et al.), 2017, DenseNet (Huang et al.), 2017, DPN (Chen et al.), 2017, YOL09000 (Redmon and Farhadi), 2017, Hourglass (Newell et al.), 2016, MobileNet (Howard et al.), 2017, DCN (Dai et al.), 2017, RetinaNet (Lin et al.), 2017, Mask R-CNN (He et al.), 2017, RefineDet (Zhang et al.), 2018, Cascade RCNN (Cai et al.), 2018, NASNet (Zoph et al.), 2019, ComerNet (Law and Deng), 2018, FSAF (Zhu et al.), 2019, SENet (Hu et al.), 2018, ExtremeNet (Zhou et al.), 2019, NAS-FPN (Ghiasi et al.), 2019, Detnas (Chen et al.), 2019, FCOS (Tian et al.), 2019, CenterNet (Duan et al.), 2019, EfficientNet (Tan and Le), 2019, AlexNet (Krizhevsky et al.), 2012;
networks specializing in image generation, e.g. Cycle-Consistent Adversarial Networks (2017), Augmented CycleGAN (2018), Deep Photo Style Transfer (2017), FastPhotoStyle (2018), pix2pix (2017), Style-Based Generator Architecture for GANs (2018), SRGAN (2018).

The above list is not exhaustive.

Training a neural network consists in improving it with a training base containing information on the two types of object that the neural network must learn to “match”, that is, connect to each other.

Training can be based on a learning base made up of records, each comprising a first object of a first type and a corresponding second object of a second type.

Alternatively, training can be carried out using a learning base made up of records, each of which contains either a first object of a first type, or a second object of a second type, but each record contains information relating to the type of object it contains. Such training techniques are described, for example, in the article by Zhu, Jun-Yan, et al. “Unpaired image-to-image translation using cycle-consistent adversarial networks.”, 2017 IEEE International Conference on Computer Vision (ICCV).

Training the neural network with these records teaches it to provide, from any object of the first type, a corresponding object of the second type.

The quality of the analysis performed by the neural network depends directly on the number of records in the training database. Preferably, the learning base comprises more than 10,000 records.

By “computer” we mean a computer processing unit, which includes a set of several machines with computer processing capabilities. In particular, this unit can be integrated into a cell phone, or be a PC-type computer or server, for example a server remote from the user, e.g. being the “cloud” or a computer located at a dental care professional's premises. The image-acquiring apparatus and the computer then comprises communication means for exchanging information between them, in particular for transmitting the updated image(s).

Typically, a computer comprises a processor, a memory, a human-machine interface, typically comprising a screen, and a communication module via the Internet, WIFI, Bluetooth® or the telephone network. Software configured to implement a process of the invention is loaded into the computer's memory. The computer can also be connected to a printer, such as a 3D printer.

“Comprise”, “include” and “have” are to be interpreted broadly and without limitation, unless otherwise specified.

### BRIEF DESCRIPTION OF THE FIGURES

Further features and advantages of the invention will become apparent from the following detailed description and from an examination of the appended drawing, provided for illustrative non-limiting purposes. In the attached drawing:

FIG. 1 schematically shows a manufacturing process according to the invention;

FIG. 2 shows a treatment scenario;

FIG. 3 shows an example of a dental arch model;

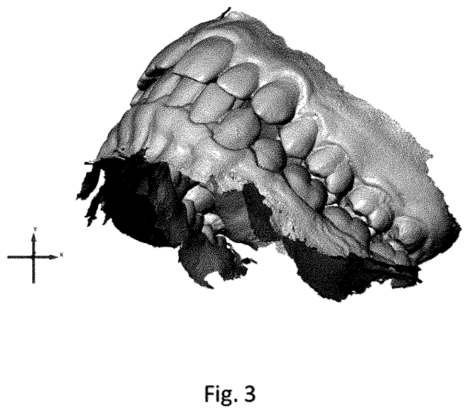

FIG. 4 shows an example of an arch model divided into tooth models;

FIG. 5 shows a kit according to the invention;

FIG. 6 shows the deformation of a reference model according to the invention.

### DETAILED DESCRIPTION

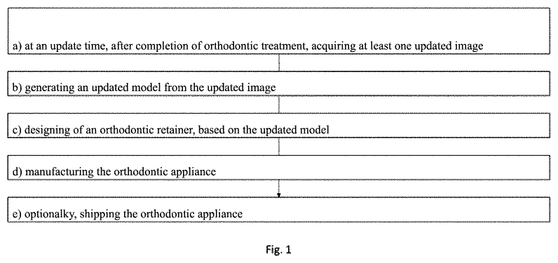

FIG. 1 shows an example of a manufacturing process according to the invention. This manufacturing process comprises steps a) to d), preferably steps a) to e).

In step a), an updated image 22, preferably a photograph, representing a dental arch of a user is acquired by means of an image-acquiring apparatus 20, in order to update a reference model 32 representing said dental arch of the user.

Alternatively, the updated image is acquired by video acquisition, with the user's dental arch being filmed using the image-acquiring apparatus. The updated image can be extracted from this video.

Step a) is performed at an update time, the update time being after orthodontic treatment. Preferably, acquisition is carried out less than six months, preferably less than three months, more preferably less than one month, and even more preferably immediately after completion of orthodontic treatment.

The acquisition of step a) can be carried out by the user, a relative or a dental care professional. Preferably, acquisition is carried out by the user on their own.

The image-acquiring apparatus 20 can be a cell phone, a tablet, a camera, or a computer, the image-acquiring apparatus preferably being a cell phone.

Preferably, multiple updated images 22 are acquired. The updated images may comprise a front-view image, a left-view image and a right-view image. The updated images can be taken for the upper arch, the lower arch, or both. The updated images can be taken with the user's mouth open or closed. Preferably, the updated images are in color, preferably in realistic color.

In step b), an updated model 42 is generated based on the updated image acquired in step a), the model being generated without the user needing to be physically present in the dental surgery, preferably the user is not physically present in the dental surgery.

Several methods are available.

In one embodiment, the updated model is generated directly from the updated image(s), preferably using at least one neural network.

The at least one neural network is pre-trained so that the neural network learns to output an updated model from one or more updated input images.

Training is carried out using a training base comprising historical images and historical models, the historical images being comparable to updated images, and the historical models being comparable to updated models. A historical model can be acquired by means of a 3D scanner substantially at the time when the corresponding historical image was acquired, or it can be generated manually. A record in the learning database may comprise a historical image as the first object and a historical model as the second object. The neural network can be told that for a first object comprising a historical image, it must match a second object comprising a historical model. In particular, to train the neural network, it will be provided with a set of first objects and a set of second objects so that it can learn to match a first object with a second object. Once trained, the neural network is then able to determine an updated model as output, when given an updated image as input.

Preferably, the first object comprises a plurality of updated images, the at least one neural network being trained to generate, as an output, an updated model from a plurality of updated images supplied to it as an input.

The at least one neural network can be a reconstruction neural network, that is, an occupancy neural network.

The occupancy neural network is trained to output a 3D model of at least part of a dental arch constructed from a plurality of updated images representing the at least part of the dental arch. Preferably, an occupancy neural network takes as input only updated images representing at least part of the user's dental arch.

In another embodiment, a reference model 32 is determined. The reference model can be selected manually, for example from a set of 3D models stored in a database 30, representing the user's dental arch. Preferably the reference model is determined automatically, that is, without human intervention, preferably by computer.

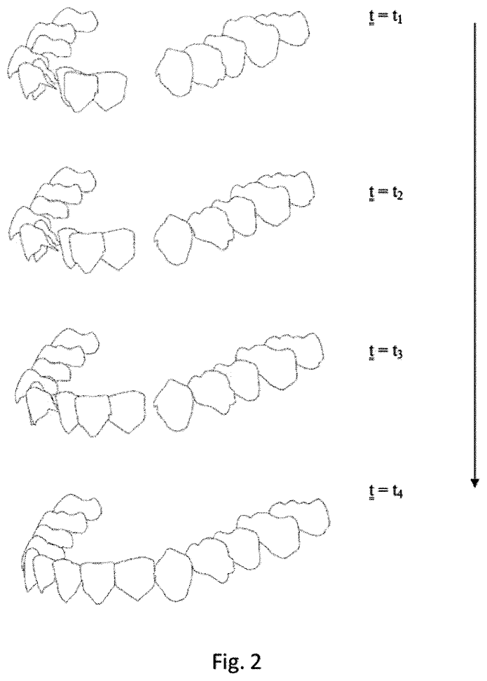

The selected reference model 32 is preferably an intermediate model or a final model, created when determining the orthodontic treatment scenario. An orthodontic treatment scenario is shown in FIG. 2. The reference model 32 preferably corresponds to a 3D model acquired before the start of orthodontic treatment by means of a 3D scanner, also known as the “initial model”, which has been modified to represent the theoretical configuration of the teeth at an intermediate moment of the orthodontic treatment, also known as the “intermediate model”, or at the final moment of the orthodontic treatment, also known as the “final model”. Preferably, the reference model corresponds to the final model.

The reference model can be selected from a database. Alternatively, the reference model can be sent, for example by the dental care professional or technician, by digital communication, preferably via a specialized application.

The reference model 32 is then deformed to obtain an updated model 42 representing the configuration of the user's teeth at the update time.

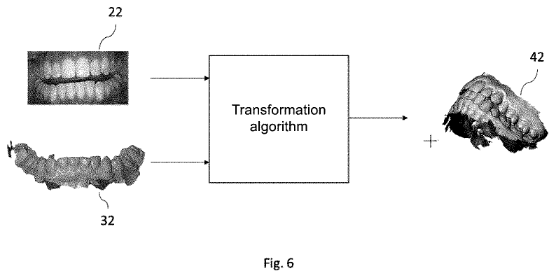

FIG. 6 shows the deformation of a reference model using a transformation algorithm. The transformation algorithm receives as input the reference model 32 and the updated image 22, then deforms the reference model according to the updated image to determine an updated model 42 compatible with the updated image.

The transformation algorithm can be a metaheuristic process, preferably comprising the following steps:
searching for a position, orientation and calibration of a virtual acquiring apparatus, collectively referred to as “virtual acquisition conditions”, which best match the actual acquisition conditions of the updated image;
comparing the view of the reference model under virtual acquisition conditions and the updated image;
deforming the reference model so that the positioning of the teeth observed on said view under virtual acquisition conditions corresponds to the positioning of the teeth observed on the acquisition image.

Deformation is therefore performed to update the reference model at the moment at which the acquisition image was acquired.

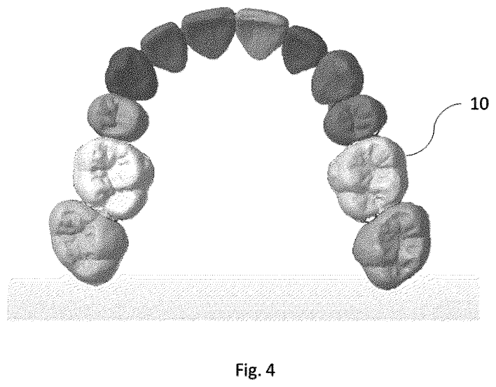

Preferably, the reference model is pre-cut into tooth models, as shown in FIG. 4, the deformation comprising the moving of said tooth models. In one embodiment, deformation involves moving tooth models whose shape remains constant.

In particular, the search for said virtual acquisition conditions and said comparison can be carried out according to the teaching of PCT/EP2015/074896.

Alternatively, the transformation algorithm comprises at least one neural network.

The at least one neural network is pre-trained so that the neural network learns to output an updated model, based on an updated image and reference model both provided as input.

Training is carried out using a training base comprising historical images, first historical models and second historical models, the historical images being akin to updated images, the first historical models being akin to reference models and the second historical models being akin to updated models. Preferably, each second historical model is determined from a historical image and a corresponding first historical model, for example manually, or is acquired by means of a 3D scanner substantially at the time at which the corresponding historical image was acquired. A record in the learning database may comprise a historical image and first historical model as the first object and a second historical model as the second object. The neural network can be told that for a first object comprising a historical image and a first historical model, it must match a second object comprising a second historical model. In particular, to train the neural network, it will be provided with a set of first objects and a set of second objects so that it can learn to match a first object with a second object. Once trained, the neural network is then able to determine an updated model as output, when given an updated image as input and a reference model.

In particular, if several updated images are available, it is possible to use reinforcement networks of the PPO type, as described on the following website: https://openai.com/blog/openai-baselines-ppo/.

The PPO neural network can be configured to iteratively modify the position of the teeth of a 3D model representing at least part of a dental arch of the user based on at least two updated images supplied as input to the neural network so that the 3D model, once modified, maximally matches the images supplied as input, the at least two updated images being images representing at least part of the dental arch of the user acquired with different acquisition angles. The provision of multiple updated images acquired at different acquisition angles makes it possible to calculate tooth movements in three dimensions using the triangulation principle.

Advantageously, such neural networks do not require any data other than the updated images as input to modify the 3D model available to the neural network.

To train the neural network, it is told the final position of the teeth expected as output. The neural network can then learn to correct the result it outputs (an “output” 3D model) by comparing the position of the teeth in this “output” model with the expected final position of said teeth. The deviation between the expected tooth position and the position of said teeth in the output model provided by the neural network can be calculated, for example, in millimeters, or degrees, or can be a surface tolerance, or a Euclidean LL distance

Compared with a PPO neural network, an occupancy neural network may be less accurate, particularly when certain portions of the at least one part of the dental arch are not represented on the plurality of updated images supplied as input to the neural network. Advantageously, a previously acquired 3D model of the user's dental arch can be used to reconstruct the missing portions. The previously acquired 3D model of the user's dental arch may also provide dimensional information, in millimeters for example, which cannot be deduced from the plurality of updated images provided as input alone.

In another embodiment of step b), the updated model is generated based on the updated image, preferably from a set of several updated images, and from a library of tooth models under a modeling process comprising, for each updated image, the following steps:
1) analysis of the updated image to determine at least one tooth zone and at least one tooth attribute value associated with said tooth zone, preferably a type or number of the tooth to which the tooth zone belongs;
2) for each tooth zone determined in step 1), searching, in a historical library comprising more than 1000 tooth models associated with said tooth attribute value, called “historical tooth models”, to find a historical tooth model having maximum proximity to the tooth zone, called the “optimal tooth model”;
3) arranging the set of optimal tooth models to create a model that maximally matches the updated image.

The library of tooth models is preferably created prior to step a) of the manufacturing process according to the invention. Preferably, the library of tooth models comprises more than 2,000, preferably more than 5,000, most preferably more than 10,000 historical tooth models. The greater the number of historical tooth models, the more accurate the assembled model.

The tooth attribute is used to filter historical tooth models to limit the search to teeth with the same tooth attribute value as the tooth represented by the tooth zone in the updated image.

One or more tooth attributes, in particular selected from tooth number, tooth type, tooth shape parameter, e.g. a tooth width, in particular mesio-palatal width, thickness, crown height, deflection index mesial and distal to the incisal edge, or abrasion level, tooth appearance parameter, in particular translucency index or color parameter, parameter relating to the state of the tooth, e.g. “abraded”, “broken”, “decayed” or “fitted” (that is, in contact with an orthodontic appliance), user's age, or a combination of these attributes, can be associated with the tooth models.

Preferably, the modeling process comprises the following optional steps:
4) optionally, replacing at least one optimal tooth model with another tooth model, a historical one, and repeating in step 3) so as to maximize the match between the assembled model and the analysis image;
5) optionally, repeating step 1) with another updated image and, in step 3) and/or 4), searching for a maximal match with the set of updated images used.

The accuracy of the assembled model can be increased if several updated images are processed.

In step 1), the updated image is analyzed, preferably by subjecting it to a neural network trained to determine at least one tooth zone and at least one tooth attribute value associated with said tooth zone.

At the end of step 1), an updated image is obtained, enriched with a description providing, for each tooth zone, a tooth attribute value for at least one tooth attribute, for example a tooth number.

In step 2), for each tooth zone determined in the previous step, the historical library is searched to find a historical tooth model with maximal proximity to the tooth zone. This tooth model is referred to as the “optimal tooth model”.

Preferably, a historical tooth model is sought that has, for at least one tooth attribute, the same value as said tooth zone. In particular, the tooth attribute can relate to the tooth type or tooth number. In other words, historical tooth models are filtered to examine in greater detail only those that relate to the same tooth type as the tooth represented on the tooth zone.

Alternatively, or preferably, in addition to this comparison of attribute values, the tooth shape represented on the tooth zone can be compared with the shape of a historical tooth model to be evaluated, preferably by means of a metaheuristic, preferably evolutionary, preferably simulated annealing process.

To this end, the historical tooth model to be assessed is viewed from different angles. Each view thus obtained is compared with the updated image, preferably with the tooth zone, so as to establish a “distance” between this view and said updated image or, preferably, said tooth zone. The distance thus measures the difference between the view and the tooth zone.

For each historical tooth model tested, a view is determined that provides a minimum distance to the updated image or to the tooth zone. Each historical tooth model examined is thus associated with a particular minimum distance, which measures its formal proximity to the tooth zone.

The optimal historical tooth model is the one which, based on the comparison(s) carried out, is considered to be closest to the tooth zone.

The minimum distances obtained for the different tooth models tested are then compared, and the tooth model with the smallest minimum distance is used to define the optimum tooth model. The optimal tooth model is therefore the closest match to the updated image.

The search for the maximal match is preferably carried out using a metaheuristic process, preferably evolutionary, preferably simulated annealing.

In a preferred embodiment, a first evaluation of the historical tooth models is carried out successively by comparing the values of at least one tooth attribute, for example the tooth number, with the corresponding values of the tooth analysis zone, followed by a second evaluation by shape comparison. The first, rapid evaluation advantageously makes it possible to filter out historical tooth models, so that only the historical tooth models retained by the first evaluation can be submitted to the second, slower evaluation.

Preferably, several first evaluations are carried out before the second evaluation.

At the end of step 2), an optimal tooth model is associated with each tooth zone.

In step 3), an assembled model is created by arranging the optimal tooth models.

A first rough arrangement can be established by considering the tooth attribute values of the optimal tooth models. For example, if the tooth numbers of optimal tooth models are those of the canines and incisors, these tooth models can be arranged in an arc that conventionally corresponds to the region of the arch that bears these types of teeth.

The shape of this arc can be refined according to other tooth attribute values.

The order of the optimal tooth models is that of the corresponding tooth zones.

Furthermore, the maximum proximity, or “minimum distance”, associated with an optimal tooth model results from an observation of the tooth model along an observation point. In other words, it is likely that the tooth modeled by this model is also observed in the updated image. The optimal tooth models are thus preferably oriented so that their surfaces, which correspond to their respective tooth zones on the updated image, are observed from the same observation point.

In this way, an initial arrangement of optimal tooth models can be defined.

Preferably, the first arrangement of optimal tooth models is then iteratively modified, so as to offer a maximum match with the updated image.

In another embodiment of step b), the updated model (or a reference model intended to be deformed to generate the updated model) is generated by implementing a process for generating a digital three-dimensional model of a dental arch comprising the following steps:
I) projecting at least one light beam onto the user's dental arch, so as to place at least one light mark on the arch;
II) simultaneously with step I), moving the dental arch through the beam and acquiring, during said movement, a series of “marked” images of said arch, each showing a representation of the projected mark, or “updated projection”;
III) identifying said projection on each marked image, then producing a digital three-dimensional model that maximally matches the set of said updated projections.

Preferably, a structured light beam is projected in step I).

In step III), the updated model can be searched for using an optimization process and/or one or more neural networks.

In step III), to produce the updated model, it is possible to modify a model defined according to user characteristics, or a model from a database, for example an initial model, an intermediate model or a final model.

In step III), the updated model can be determined as the test model obtained at the end of the following cycle of steps i) to iii):
i) creating a model to be tested, then
ii) determining a distance representative of the difference between the set of updated projections and the model to be tested, then,
iii) if said representative distance exceeds a predetermined acceptability threshold, modify the model to be tested and return to step i).

The representative distance can be evaluated from elementary distances, each elementary distance being determined, for a respective updated projection, by evaluating the difference between said updated projection and an optimal reference projection, a reference projection being a representation, on a reference image representing a view of the model to be tested, of a virtual light mark resulting from the projection, onto the model to be tested, of a virtual light beam of the same shape as the light beam projected onto the arch in step I), the optimum reference image being the reference image showing the reference projection which has a minimum distance from the updated projection.

The model to be tested can be segmented to define tooth models, and the modification of the model to be tested comprises moving and/or deforming the tooth models.

The first test model to be modified can be a dental arch model, preferably selected according to user characteristics, or a model from a database, for example an initial model, an intermediate model or a final model.

In step III), at least one, preferably two, of the following methods is used: optimization methods, artificial intelligence methods, dimension evaluation methods involving stereovision, dimension evaluation methods involving analyzing the shape of the light mark, and dimension evaluation methods involving distance analysis.

In step c), a retainer 44 is designed on the basis of the updated model 42. The design can be done manually, for example by a technician or dental care professional.

Alternatively, the design is carried out by software, preferably automatically, that is, without human intervention. The retainer is designed to keep the user's teeth in the configuration they are in at the update time.

To ensure this, the shape of the orthodontic appliance conventionally conforms to that of the patient's dental arch at the update time, so that the orthodontic appliance does not exert, at the update time, any action tending to move the teeth.

Preferably, the retainer is an archwire designed to be secured, e.g. bonded, to the user's teeth. Alternatively, the retainer is an orthodontic retaining tray.

The design of the retainer consists in determining the shape of the appliance to keep the teeth in their configuration at the update time.

In step d), the retainer 52 is manufactured.

In one embodiment, the manufacturing results from an impression made on a part physically representing the updated model. In such a case, steps c) and d) are combined. For example, a metal wire can be pressed onto a plaster or polymer cast, physically representing the updated model, to create an archwire. A polymeric tray can also be molded onto such a part.

The retainer can also be made directly based on the updated model, for example by designing a 3D model of the retainer and then manufacturing it, for example by printing it with a 3D printer.

Preferably, when the retainer is an archwire, a transfer tray is also manufactured, the transfer tray enabling the retainer to be easily positioned on the user's teeth. First, the archwire is positioned in the orthodontic transfer tray using an adhesive substance. In a second step, the orthodontic transfer tray is placed in the service position on the user's teeth. This facilitates transport, as well as the positioning and securing of the archwire. In particular, the arch can be positioned and fixed in a single step. And because the orthodontic transfer tray is based on a three-dimensional model of the user's dental arch, the archwire can be precisely positioned. The article “Méthode simple et rapide de contention indirecte” by Christine Muller et al, Orthod Fr 2009; 80:233-238, EDP Sciences, SFODF, 2009 DOI: 10.105 l/orthodfr/2009006, describes an example of a process for manufacturing an orthodontic transfer tray.

In optional step e), the manufactured retainer is sent, preferably to the dental care professional or user. Instructions on how to wear and/or position the retainer can be supplied with the retainer. Advantageously, the user does not have to visit the dental care professional, either to acquire a 3D model using a 3D scanner, or to receive the retainer and/or have the retainer positioned in their mouth.

Preferably, steps b) and c) are implemented by computer, preferably without human intervention. Step d) and/or e) can also be performed without human intervention. After step c), the computer implementing step c) can communicate design instructions for manufacturing the retainer to a manufacturing device 50.

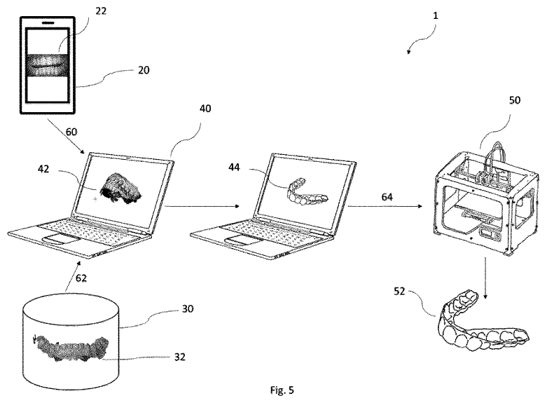

FIG. 5 schematically illustrates a design kit 1 according to the invention.

The design kit 1 comprises an image-acquiring apparatus 20, preferably a cell phone, and a computing system 40, for example a computer, comprising a computer program product configured to implement step b) of a manufacturing process according to the invention, better to implement steps b) to c) of a manufacturing process according to the invention. The computer program product can also be configured to send design instructions 64 directly to a manufacturing device 50.

The image-acquiring apparatus 20 can communicate with the computing system to transmit the acquired updated image(s) 60 to the computing system 40, via digital communications. In a particular embodiment, the acquiring apparatus, and computing system are integrated into a cell phone.

The reference model can be taken from a database 30, accessible via digital communications to the computing system. The reference model can be transmitted 62 to the computing system, in particular by being downloaded. The database can be on a remote server.

The design kit 1 may comprise the manufacturing device, the manufacturing device preferably being configured to communicate with the computing system. Once the retainer has been designed, the computing system 40 can send manufacturing instructions 64 to the manufacturing device 50.

### Example

An updated image 22 is acquired using a cell phone 20, preferably by the user, preferably remotely from a dental or orthodontic practice.

The updated image 22 is sent to a computing system 40. The computing system may or may not be integrated into the cell phone. Preferably, the computing system is a specialized application that can be installed on the cell phone.

The computing system 40 can preferably communicate with a database 30 containing intermediate, initial and final models from one or more orthodontic treatment scenarios, representing configurations of the user's dental arch. The intermediate and final models represent theoretical configurations of the user's dental arch. The initial model is a model acquired by the dental care professional, classically, preferably by means of a 3D scanner. In step b), the reference model is determined by selecting a model from database 30.

Alternatively, in step b), the reference model 32 is selected manually and sent to the computing system 40, for example by the dental care professional or a technician.

Based on the updated image 22 and reference model 32, the computing system 40 can determine the updated model 42, as described in step c) of a process according to the invention.

The computing system 40 can then, using the updated model 42, design a retainer 52, as described in step d) of a process according to the invention, optionally with the help of an operator or dental care professional. Determining the updated model (step c)) and designing the retainer (step d)) can be carried out remotely from each other. The computing system may comprise multiple processors.

Preferably, the cell phone comprises a dedicated application configured to implement steps a) to c) according to the invention, preferably steps a) to d) according to the invention.

Step d) of retainer design makes it possible to determine the manufacturing instructions for said retainer. The retainer 52 may be an archwire or an orthodontic retaining tray. Advantageously, these instructions are sent to a manufacturing device 50.

The manufacturing device produces the retainer from the instructions. The manufacturing device can be a 3D printer. The 3D printer can be installed on the user's premises.

Once manufactured, the retainer can be sent directly to the user. Preferably, when the retainer is an archwire, it is shipped in a transfer tray, which, in addition to the archwire, comprises adhesive for securing the archwire to the user's teeth when the transfer tray is positioned over said user's teeth.

As will become clear by now, a process according to the invention makes it possible to manufacture a retainer based on one or more updated images, preferably photos taken by the user, and a reference model acquired when the teeth had not yet reached their final configuration. This manufacturing process can therefore be carried out without an orthodontist intervening specifically for this purpose, saving the user the need to make an appointment with the orthodontist.

Thus, by acquiring simple extra-oral images of the user's teeth, that is, images acquired by means of an image-acquiring apparatus located outside the user's mouth at the time of acquisition, it is possible to design and manufacture a retainer, without the user needing to physically consult their dental care professional. In particular, a process according to the invention makes it possible to manufacture archwires intended to be positioned on an inner surface of the user's teeth, from the acquisition of extra-oral images, representing in particular outer surfaces of the user's teeth.

Of course, the invention is not limited to the above-described and illustrated embodiments.

1. A process for modeling a retainer of a patient, said process comprising the following steps:
prior to step a), during orthodontic treatment, generating a reference model representing the user's dental arch;
a) at an update time, at the end or after the end of orthodontic treatment, acquiring at least one two-dimensional image of at least part of a dental arch of a user, called the “updated image”, by means of an image-acquiring apparatus;
b) generating a digital three-dimensional model representing the user's dental arch, known as the “updated model”, based on the updated image, the updated model being obtained by deforming the reference model from the updated image;
c) designing, based on the updated model and preferably by computer, a retainer suitable for keeping teeth in their configuration at the update time;
d) manufacturing the retainer.

2. The process according to claim 1, wherein the acquisition of the updated image is carried out by the user, preferably outside an orthodontic or dental practice.

3. The process according to claim 1, wherein the retainer is an archwire or an orthodontic retaining tray, preferably an archwire.

4. The process according to claim 1, wherein the reference model represents the user's dental arch in a desired theoretical configuration at an intermediate moment of the orthodontic treatment or at a final moment of the orthodontic treatment, referred to as the “intermediate model” or “final model” respectively.

5. The process according to claim 1, wherein the reference model is a final model.

6. The process according to claim 1, wherein, in step b), the reference model is obtained
by means of a LIDAR integrated into a user's cell phone or by implementing a dental arch modeling process, preferably by a user's cell phone, said modeling process comprising the following steps:
1. analyzing an updated image representing the dental arch of the user so as to determine at least one tooth zone and at least one tooth attribute value associated with said tooth zone, preferably a type or number of the tooth to which the tooth zone belongs;
2. for each tooth zone determined in step 1), searching, in a historical library comprising more than 1000 tooth models associated with said tooth attribute value, called “historical tooth models”, to find a historical tooth model having maximum proximity to the tooth zone, called the “optimal tooth model”;
3. arranging the set of optimal tooth models to create a model that maximally matches the image analyzed in step 1), said image being, to obtain the updated model, a said updated image, or, to obtain the reference model, an image acquired before the update time.

7. The process according to claim 1, wherein, in step b), the reference model is obtained by implementing a process for generating a digital three-dimensional model of a dental arch comprising the following steps:
I) projecting at least one light beam onto the user's dental arch, so as to place at least one light mark on the arch;
II) simultaneously with step I), moving the dental arch through the beam and acquiring, during said movement, a series of “marked” images of said arch, each showing a representation of the projected mark, or “projection”;
III) identifying said projection on each marked image, then producing a digital three-dimensional model that maximally matches the set of projections.

8. The process according to claim 1, comprising, after step d), a step e):
e) shipping the retainer, preferably to the user or dental care professional.

9. The process according to claim 1, wherein the acquiring apparatus is a cell phone and/or the retainer is manufactured using a 3D printer.
